(19) United States
(12) Patent Application Publication
(10) Pub. No.: US 2005/0195102 A1
(43) Pub. Date: Sep. 8, 2005

(54) Real time predictive trajectory pairing (RTPTP) algorithm for highly accurate tracking of ground or air moving objects

(76) Inventors: Dhadesugoor R. Vaman, Frederick, MD (US); Siew T. Koay, Waller, TX (US)

Correspondence Address: DHADESUGOOR R. VAMAN, 8399 BUCKEYE COURT, FREDERICK, MD, 21702, US

(21) Appl. No.: 10/651,325

(22) Filed: Mar. 5, 2004

(51) Int. Cl. G01S 13/66

(52) U.S. Cl. 342/90; 342/195; 342/95; 342/97

(57) ABSTRACT

The proposed invention describes the teaching of the Real Time Predictive Trajectory Pairing (RTPTP) polynomial and its use for tracking moving objects on ground or over the air using four previous locations as reference to track the next location. It also teaches the use of a windowing mechanism of taking previous locations to compute the next location as part of a continuous tracking method. The proposed invention provides very accuracy of tracking over that of GPS-based systems. Therefore, the applications including homeland security and future combat systems would immensely benefit in the wake of different types of wars and to combat terrorism.

### I. BACKGROUND OF THE INVENTION

Highly accurate prediction for tracking moving objects over the air or on ground is a very important requirement for both military and commercial systems. The current location tracking by Global Positioning Satellite (GPS) based algorithms are quite adequate for most commercial systems; they are not accurate enough for military systems. It is desired that the accuracy of the order be significantly less than 1 meter to reduce friendly fires and missile tracking.

Today, almost all tracking methods that have been implemented are based on GPS System. In fact, current GPS system uses 23 satellites to predict the position and achieve accuracy of around 2-3 meters for stationary objects or locations. The location tracking of moving objects have lower accuracies than the tracking of stationary objects.

Commercial applications include “shipping of goods (e.g. UPS, FEDEX)”, “tracking of automobiles used for tracking stolen vehicles” and “US Military—Forward Combat Theater”. Also, tracking the space shuttle for reentry requirements uses GPS. In all of these applications, the accuracy happens to be limited to the range of about 3 meters to about 20 meters. While the accuracy is acceptable to many commercial applications, it is not acceptable to the combat theaters or advanced telemedicine applications.

The proposed invention provides the teaching of the Real Time Predictive Trajectory Pairing (RTPTP) polynomial and its use for tracking moving objects on ground or over the air (spatial) using four previous locations as reference to track the next location. It also teaches the use of a windowing mechanism of taking previous locations to compute the next location as part of a continuous tracking method. The proposed invention provides high accuracy over GPS-based systems. RTPTP is highly accurate to the order of one millimeter per one kilometer tracking distance. Therefore for real applications to homeland security to target terrorists and future combat systems that require accurate tracking of all network elements of the forward area theater, this system is highly applicable. The network elements include missiles, tanks and soldiers in the theater.

### II. BRIEF SUMMARY OF THE INVENTION

The proposed invention teaches the use of RTPTP algorithm to accurately predict the position of the moving object(s) and can also enable continuous tracking of moving objects. The fact that the algorithm is capable of predicting the moving objects automatically implies that it can track stationary objects as well. In addition, the moving object can move in any direction and the RTPTP algorithm can track that object and maintain significantly higher accuracy than currently available GPS methods.

The invention also teaches the use of RTPTP algorithm for creating a distributed network centric architecture where different reference points each have RTPTP algorithm to track object(s) continuously and accurately. The basic transport system to exchange the information between “multiple pairs of reference points” and between “the reference points within each pair”.

### III. BRIEF DESCRIPTION OF THE DRAWINGS

a. Table 1—Illustration of tracking (Example 1)

The first example of object tracking demonstrates the accuracy of the tracking.

b. Table 2—Illustration of tracking (Example 2)

This is the second example of object tracking.

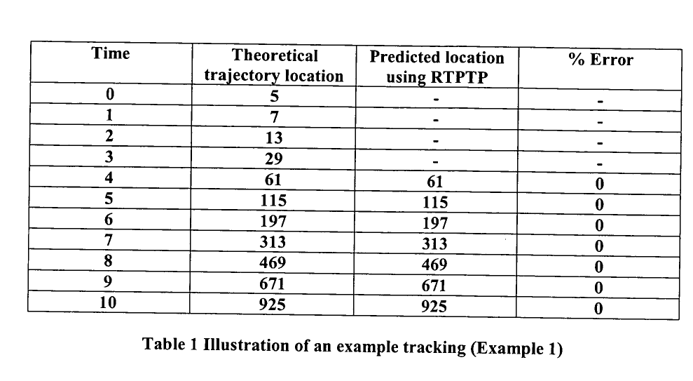

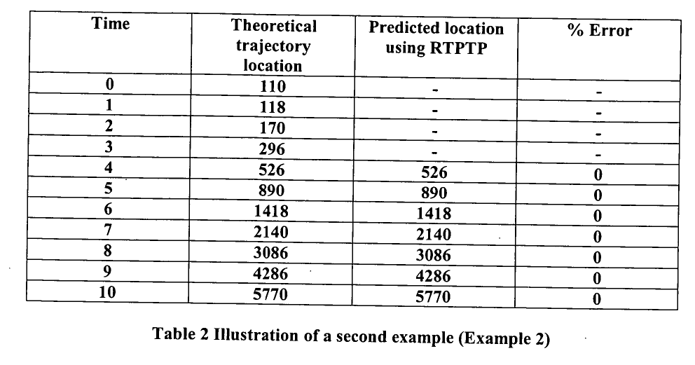

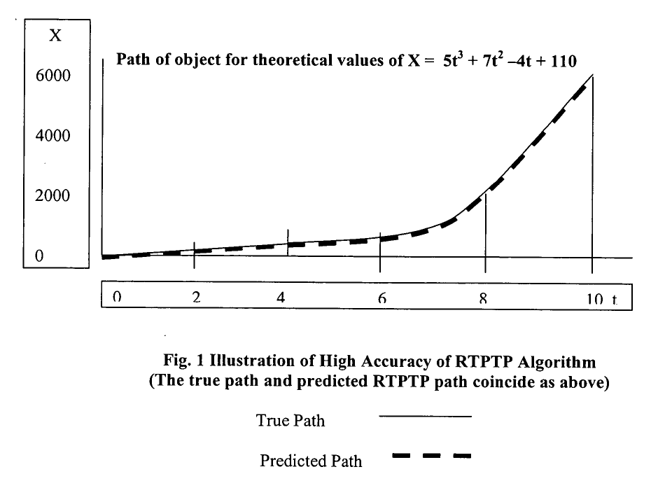

c. FIG. 1—Illustration of the high accuracy RTPTP algorithm

This illustrates the close matching of object location between the theoretical and RTPTP algorithm

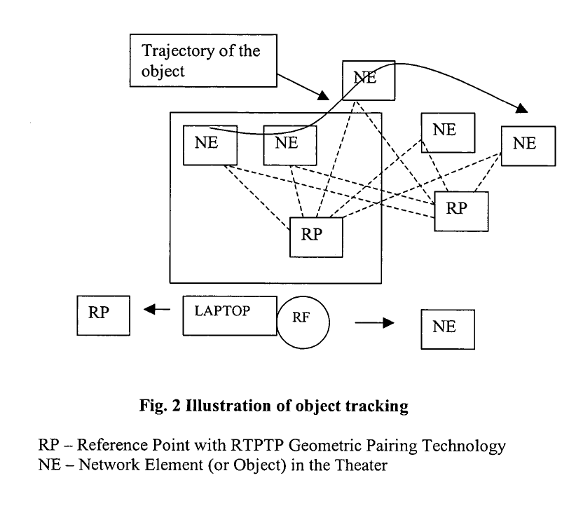

d. FIG. 2—Illustration of Object Tracking

This illustrates a typical configuration where objects can move in-doors as well as out-doors. In addition, with in-door, the objects can move in different floors.

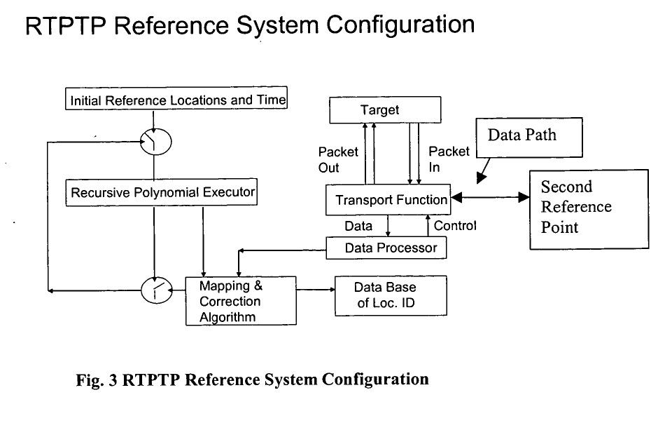

e. FIG. 3—RTPTP Reference System Configuration

This figure illustrates the basic block diagram of how the RTPTP system is implemented.

### IV. DETAILED DESCRIPTION OF THE INVENTION

IV.1 Algorithm

The Real Time Predictive Trajectory Pairing (RTPTP) algorithm is based on a polynomial of nth order where n has to be at least 3. The general polynomial for the vector distance of the object from a reference point R1 is defined by:

$$X ( t ) = {\sum }_{k = 0}^{n} {a}_{k} {t}^{k} \qquad ( 1 )$$

where n=order of the polynomial, aₖ is the coefficient of the kth order of t, and t is the time during which the object is located. X(t) describes the trajectory of the moving object in time.

$${d}_{j} = [ {\prod }_{\begin{matrix}i = 0 \\ i \neq j\end{matrix}}^{m - 1} ( {t}_{m} - {t}_{i} ) ] / [ {\prod }_{\begin{matrix}i = 0 \\ i \neq j\end{matrix}}^{m} ( {t}_{j} - {t}_{i} ) ] \qquad ( 2 )$$

where dⱼ are the coefficients created for use in computing the vector distance X(m) of the object from the reference point R1 in order to continuously track the object(s) based on the m immediately preceding locations:

$$X ( {t}_{m} ) = {\sum }_{k = 0}^{m - 1} {d}_{k} * X ( {t}_{k} ) \qquad ( 3 )$$

IV.2 Verification of the RTPTP Algorithm by Examples

To demonstrate the accuracy of the algorithm, we make the following assumptions in Equation (1): n=3; a₃=1, a₂=−1, a₁=2 and a₀=5. Then,

$$\begin{matrix}X ( t ) = {t}^{3} - {t}^{2} + 2 t + 5 & ( 4 ) \\ {d}_{j} = [ {\prod }_{\begin{matrix}i = 0 \\ i \neq j\end{matrix}}^{3} ( {t}_{4} - {t}_{i} ) ] / [ {\prod }_{\begin{matrix}i = 0 \\ i \neq j\end{matrix}}^{3} ( {t}_{j} - {t}_{i} ) ] & ( 5 ) \\ X ( {t}_{4} ) = {\sum }_{k = 0}^{3} {d}_{k} * X ( {t}_{k} ) & ( 6 )\end{matrix}$$

Table 1 illustrates the accuracy of the algorithm for the case n=3; a₃=1, a₂=−1, a₁=2 and a₀=5.

Consider another example where we assume: n=3; a₃=5, a₂=7, a₁=−4, aₒ=110. Therefore, equation (4) now is written as:
X(t)=5t³+7t²−4t+110 (7)

Table 2 illustrates the accuracy of the algorithm by solving Eq. (7).

In general, Equations 2 and 3 are used to continuously compute the fifth location (for the case of n=3) of the object based on its previous four locations as it moves along the trajectory. As n goes higher, it will compute the next location with higher number of previous locations. As can be seen from the table, the computation is highly accurate.

FIG. 1 illustrates the path of the object theoretical and algorithmic object locations are matched closely.

IV.3 System Design Using RTPTP Algorithm with Geometric Pairing Architecture for Position and Location Tracking Using Geometric Pairing Architecture

Geometric Pairing is a concept that enables real time tracking of all moving or fixed elements in an all wireless network centric theater. The elements (also referred to as network elements or objects with respect to tracking) include soldiers, ground vehicles and air vehicles. This concept would complement the current GPS tracking in order to improve the accuracy. In addition, the use of this concept would provide a basis of distributed architecture used to track all elements in an integrated battlefield theater.

Geometric Pairing is a proprietary technology based on open system architecture. The concept involves the use of an IP ID, time tagged based message exchange, and prediction-based algorithms [1].

IV.3.1 What is Geometric Pairing?

Geometric pairing is a self-correcting method to accurately track object(s) both indoor and outdoor within a limited coverage area. It complements GPS technology and ensures accurate tracking.

Geometric pairing technology consists of two reference points for prediction of the location. The two reference points form a pair that can be changed from one segment to another segment of the network. The reference sites actually communicate in real time with minimal bandwidth requirement. This would enable continuous tracking of moving objects.

The RTPTP algorithm provides a second level correction for accurate prediction of the location of the moving object.

IV.3.2 Basic Concept of RTPTP

The basic concept involves several steps:
a. Initialization
b. Reference Points' tracking via radio communications
c. Geometric Pairing Adjustments using the Reference Points
d. Verification by RTPTP Polynomial
e. Creation of Location Data and Reporting data via IP exchange
f. Tracking capability
   a. Initialization

It initializes with the first four reference locations of the object(s) to be tracked. The first four locations can be provided with other means such as GPS system. It will also enable RTPTP polynomial as well as the geometric pairing data to be initialized. Then it will track the object as it moves. The speed of tracking is dependent on the data rate supported by the RF technology and the accuracy of the tracking data for the first four locations. The processing time of the algorithm is significantly less than the processing time and the propagation time of the radio communication between the object and the reference point.

b. Reference Points' Tracking via Radio Communication

Each reference point tracks the object and uses its own reference origin. The communication exchange will enable it to compute the location. The data available is used for verification and adjustment between the two reference points' pairing. Any radio communications can be used. The radio communications include, but not limited to: Ultra wide band, IEEE 802.11, microwave, LMDS and others. The tracking method is transparent to any radio communications system.

c. Geometric Pairing Adjustments Using the Reference Points

Each reference point uses the data from the other to make adjustments to the location of the object. The intent of Geometric Pairing is to use a set of triangles formed between the moving object and the reference points and solve for the distances between the object and the reference point and make corrections to the distances such that a pair of triangles form a common vertex that represents the object location [1—Geometric Pairing with IP Time-Tag Technology Architecture and Management, Dhadesugoor R. Vaman, Patent Application].

For more accuracy, the number of reference points can be increased to 4. Increasing the number of reference points would enable tracking of the object in all directions.

d. Verification by RTPTP Polynomial

RTPTP uses Reference Points to execute the continuously accurate tracking of the next location(s) of the object. The data that is derived and recorded for use is used to compare the results of the adjusted data in part (c) above and a final location is computed. The technique used in the proposed invention, RTPTP, has been illustrated in Section 4.

Once the first four locations are known and initialized, the fifth location is computed. The subsequent locations are tracked by the windowing process of taking the previous four points as reference. It is a continuously variable windowing process for continuously tracking moving object(s).

e. Creation of Location Data and Reporting Data Via IP Exchange

The Location data from the distance is converted into GPS format relative to the origin. This data is stored in the database and can be reported to any other network element based on the system design requirements.

f. Tracking Capability

The overall system is capable of tracking the mobile object inside the building and outside the building and between the floors inside building. This is true as long as the radio communication is feasible through the walls. FIG. 1 illustrates a configuration of tracking of an object. The box represents in-door elements. The NE which is the object that is being tracked can move in-door or out-door as shown by the path. The two reference points (RPs) each located in-door and out-door are used for the geometric pairing. FIG. 2 illustrates the tracking of the mobile object. All Network Elements (NE) are mobile and must be tracked by the Reference Points (RP) using the RTPTP algorithm.

The Reference Points are relative in a geographic coverage area. As the object moves further and further away from a coverage area, it can be tracked by another pair of Reference points. Thus, the reference points can be located all over the network centric environment to continuously track the object. By using normal IP transport communication, the reference points exchange the tracking data across different coverage areas. Thus, it is possible to continuously track the object(s) by exchanging necessary location information between one pair of Reference Points to the next pair of Reference Points. This method allows the implementation of distributed management tracking in large network architectures.

Indirect tracking of the object is also accomplished using the RTPTP algorithm. The reference point can communicate with an object through another network element. The intermediary network element acts as a reference point for the object. The main reference point communicates with the intermediary network element (which is acting as a reference point) to derive the overall location data. The location data of an indirect object is given by:
Indirect Object Location=α₁ρ₁(τ,δ)+α₂ρ₂(τ,δ) (7)

Equation 7 represents a method of solving one of the sides based on the knowledge of the two other sides.

Summary

In summary, the RTPTP has the following features:
Initial four reference points of object(s) being tracked are established.
The accuracy of these reference points is very crucial to the accuracy of real-time tracking.
The RTPTP Polynomial runs on the reference machine that can be located anywhere.
The tracking information computed is based on the reference point (origin) of the reference machine.
Pairing requires minimum two reference points (and up to four reference points) and communication between them to match the tracking location.
Tracking of objects can be achieved in-doors (including between the floors) as well as out-doors, and indirect targeting of the objects is also achieved.
   IV.3.3 RTPTP Reference System Configuration

FIG. 3 illustrates the RTPTP Reference System Configuration. It consists of a recursive polynomial executor process, mapping and correction algorithm, transport function and database for reporting data.

In FIG. 3, RTPTP uses a recursive polynomial executor to identify the next location based on previous four locations. This geometric pairing, which uses the IP time tag approach, measures the distances and corrects to match the object location to a common vertex in two or more triangles. The number of triangles is directly proportional to the number of reference points used. For geometric pairing triangulation, the minimum number of reference points required is 2.

The geometric pairing triangulation provides the first level of adjustment to improve the accuracy of tracking object(s). The RTPTP polynomial provides an independent second level verification for very high accuracy (<<1 meter) of tracking object(s). The reference system configuration also takes the distances and then maps to coordinates that are consistent with the GPS coordinates. This data can be used to transport within any network centric environment using a basic IP transport system. The basic transport to exchange data is based on IP transport. The ID of the object will use an IP address. This ID can be changed to any customer desired combat ID.

In FIG. 3, the different components are configured as follows:
a. Target—Refers to the continuously moving network element
b. Transport Function—It receives and transmits packets that contain necessary information of the ID of the network element that is tracked, time tag information and the necessary time fields that allows the computation of total time delay that is associated with the distance of the target to the reference point.
c. Data Processor—It is part of the geometric pairing algorithm to compute the distance and adjust the distance based on the information from the second reference point about the same target. This is referred to as Geometric Pairing Adjustment.
d. Mapping and Correction algorithm—This enables verification of location data, between RTPTP recursive polynomial output that provides the computation of target location data at the next time and measured geometric paired target location data. The final data is accurately predicted and presented to the data base.
e. Data Base—This keeps a record of the location of targets with ID.
f. Recursive polynomial executor—This executes the RTPTP polynomial described by Eqs. (1)-(3).
g. Initial reference location and time is derived by the movement of the target and the corresponding location derived from GPS or other methods.

1. Teaching of the design of the RTPTP polynomial of all orders for use in tracking, i.e. n≧3. The minimum order of 3 is critical to track the moving objects that can change directions in any manner. Even the order 2 polynomial is part of this invention.

2. Teaching of the design of the RTPTP architecture is claimed to be unique.

3. Teaching of the integration of RTPTP polynomial with Geometric Pairing system (or any other system) is Creation of concept of the architecture of combining RTPTP polynomial with geometric pairing for very accurate prediction.

4. Teaching of the system design that uses RTPTP polynomial integrated with any other methods, including geometric pairing of any number of reference points.

5. Teaching of the system architecture that contains any number of reference points.

6. Teaching of explicit procedure that uses 4 points (or higher) for initialization and then subsequent continuous tracking of the objects.

7. Teaching of the reference system architecture of RTPTP as illustrated in FIG. 3.

8. Teaching of the design of distributed management architecture of object tracking with normal exchange of tracking information between one pair of reference points and a second pair of reference points.

9. Teaching of accurate tracking of both direct and indirect targets.

10. Teaching of accurate tracking of objects using any form of radio communications by preserving the algorithm transparency.

11. Teaching of accurate tracking of objects in-doors (including between the floors) and out-doors.

12. Teaching of accurate tracking of objects moving continuously between in-door and out-door.

13. Teaching of application of tracking in an all wireless network centric scenario that consists of any combination of integrated radio communications systems including all forms of radio communications.
